(19) United States
(12) Patent Application Publication
(10) Pub. No.: US 2015/0109761 A1
(43) Pub. Date: Apr. 23, 2015

(54) BACKLIGHT MODULE HAVING UNIFORM ILLUMINATION

(71) Applicant: HON HAI PRECISION INDUSTRY CO., LTD., New Taipei (TW)

(72) Inventor: YUNG-LUN HUANG, Tu-Cheng (TW)

(73) Assignee: HON HAI PRECISION INDUSTRY CO., LTD., New Taipei (TW)

(21) Appl. No.: 14/253,816

(22) Filed: Apr. 15, 2014

(30) Foreign Application Priority Data
Oct. 23, 2013 (TW) 102138176

(51) Int. Cl. G02F 1/1335

(52) U.S. Cl. CPC G02F 1/133603; G02F 1/133611
USPC 362/97.1

(57) ABSTRACT

A backlight module includes a first optical element, a plurality of LEDs, and a plurality of second optical elements. The second optical elements are located over the LEDs, and spaced from the LEDs and the first optical element. Each second optical element has a configuration of an inverted frustum of a triangular cone. The LEDs are arranged on a reflecting face of the first optical element in a number of rows and columns. The LEDs in every two adjacent rows of the LEDs are arranged zigzag. The LEDs in every two adjacent columns of the LEDs are arranged zigzag. The first optical element and the second optical elements reflect light emitted from the LEDs. The light emitted from each LED forms a triangular light field after reflected by the first optical element and the second optical element.

### BACKGROUND

1. Technical Field

The present disclosure relates to backlight modules, and more particularly to a direct-type backlight module using LEDs (light emitting diodes) as a light source and having a uniform light illumination effect.

2. Description of Related Art

LEDs have been widely promoted as light sources of backlight modules owing to many advantages, such as high luminosity, low operational voltage and low power consumption. A traditional direct type backlight module includes a number of LEDs, and a number of lenses covering the LEDs. The lenses are used for diffusing light emitted from the LEDs. The LEDs and the lenses are arranged in matrixes. Light emitted from the LEDs travels through the lenses and forms round light fields in a diffusion plate of the direct type backlight module. However, an area of the light field formed by light emitted from each LED non-linearly overlaps other areas of the light fields formed by light emitted from other LEDs neighboring the LED. As a result, an even light distribution effect of the direct type backlight module in the diffusion plate can not be achieved, whereby the direct type backlight module cannot generate a uniform illumination to an object such as an LCD (liquid crystal display).

Therefore, a backlight module which is capable of overcoming the above described shortcomings is desired.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 shows a cross sectional view of a backlight module in accordance with an exemplary embodiment of the present disclosure.

FIG. 2 shows a three-dimensional view of a second optical element of the backlight module of FIG. 1.

FIG. 3 shows an inverted view of the second optical element of FIG. 2.

FIG. 4 shows another three-dimensional view of the second optical element of FIG. 2.

FIG. 5 shows a schematic view of light fields formed by light emitted from LEDs of the backlight module of FIG. 1.

FIG. 6 partially shows a schematic view of the backlight module of FIG. 1, wherein an LED is powered to emit light.

FIG. 7 partially shows a schematic view of light fields formed by light emitted from LEDs of the backlight module of FIG. 1, in which the light fields linearly overlap each other by their edges.

### DETAILED DESCRIPTION

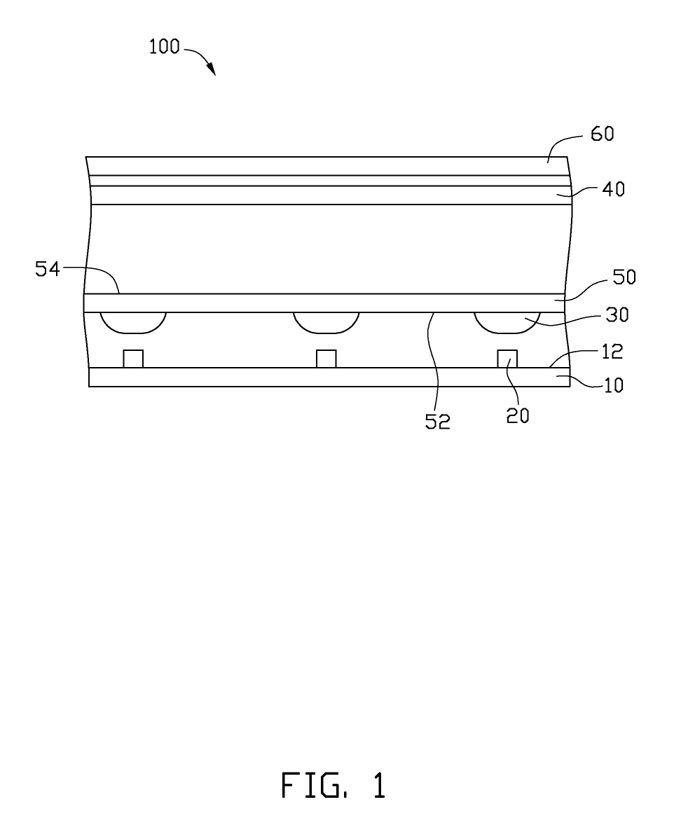

Referring to FIG. 1, a backlight module 100 in accordance with one embodiment of the present disclosure includes a plate-shaped first optical element 10, a plurality of LEDs 20 arranged on the first optical element 10, a plurality of second optical elements 30 located on a light path of the LEDs 20, a diffusion plate 40 and two light penetrating plates 50, 60. The diffusion plate 40 and the two light penetrating plates 50, 60 are spaced from each other, and located above the second optical elements 30. The backlight module 100 can be used to illuminate a planar display device such a liquid crystal display (LCD).

The first optical element 10 has a top face acting as a reflecting face 12. The reflecting face 12 faces the second optical elements 30.

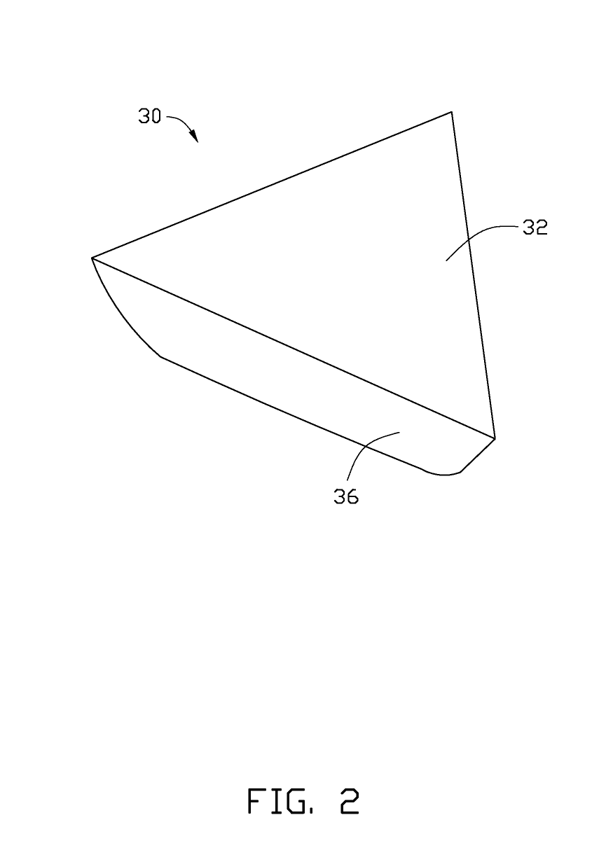

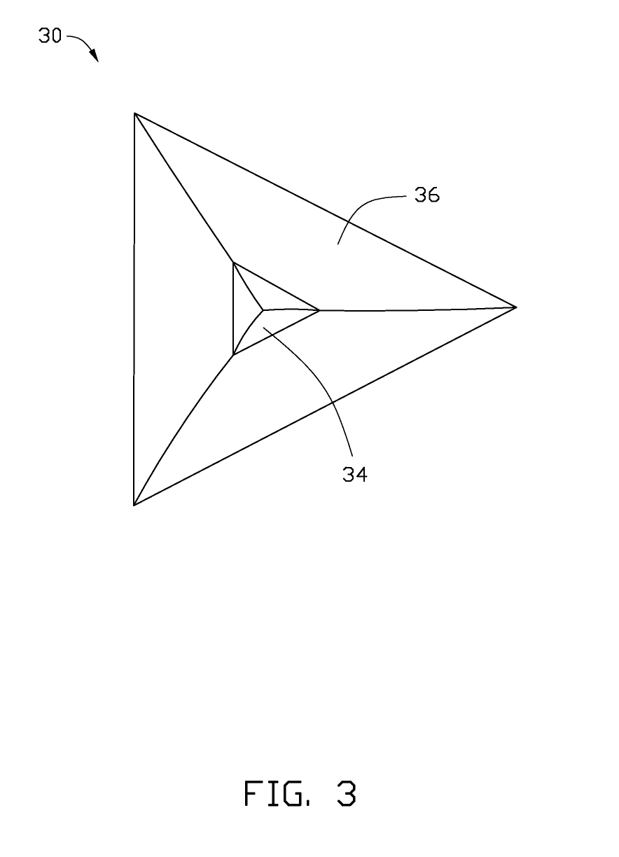

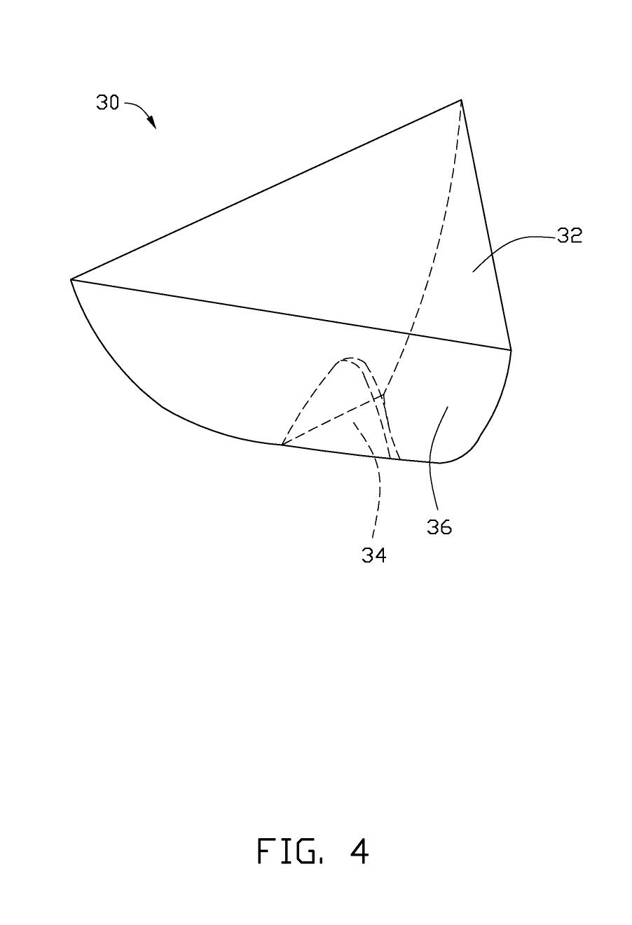

Also referring to FIGS. 2-4, the second optical elements 30 are located over and spaced from the LEDs 20 and the first optical element 10, wherein the second optical elements 30 are positioned corresponding to the LEDs 20, respectively. Each second optical element 30 has a configuration like an inverted frustum of a triangular cone, and includes a triangular top face 32, three side faces 36 connecting the top face 32, and a triangular, concave face 34 formed in a bottom of the second optical element 30. The top faces 32 of the second optical elements 30 are adhered on the light penetrating plate 50. The concave face 34 is opposite to the top face 32. The concave face 34 acts as a first reflecting face of the second optical element 30. The concave face 34 of each second optical element 30 faces the reflecting face 12 of the first optical element 10, and is oriented to a corresponding LED 20. The concave face 34 has a profile like a pyramid with three triangular side surfaces. Each side face 36 of the second optical element 30 is an arc-shaped face gradually tapering from the top face 32 to the concave face 34. Each side face 36 of the second optical element 30 faces the reflecting face 12 of the first optical element 10, and acts as a second reflecting face of the second optical element 30. FIG. 4 is added with dashed lines to more clearly show the structure of the second optical element 30.

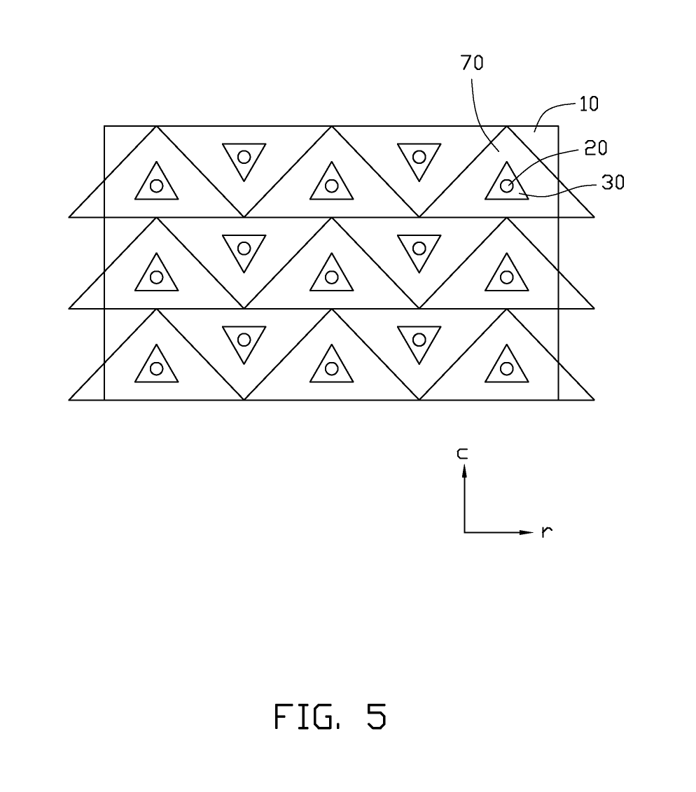

The number of the LEDs 20 is the same as that of the second optical elements 30. Each of the LEDs 20 is corresponding to one of the second optical elements 30. A light outputting face of each LED 20 faces the side faces 36 and the concave face 34 of the corresponding second optical element 30. The LEDs 20 are arranged on the reflecting face 12 of the first optical element 10 in a matrix. Referring to FIG. 5, the LEDs 20 are arranged on the reflecting face 12 of the first optical element 10 in a plurality of rows (the direction of the row is labeled as “r” in FIG. 5) and a plurality of columns (the direction of the column is labeled as “c” in FIG. 5). The LEDs 20 in every two adjacent rows of the LEDs 20 are arranged in a zigzag manner. That is, the LEDs 20 located at one row are not in alignment with the LEDs 20 located at an adjacent row along the direction “c”. The LEDs 20 in every two adjacent columns of LEDs 20 are arranged in a zigzag manner. That is, the LEDs 20 located at one column are not in alignment with the LEDs 20 located at an adjacent column along the direction “r”. To correspond with the arrangement of the LEDs 20, the second optical elements 30 are arranged on the light penetrating plate 50 in a plurality of rows and a plurality of columns. The second optical elements 30 in every two adjacent rows of the second optical elements 30 are arranged in a zigzag manner. That is, the second optical elements 30 located at one row are not in alignment with the second optical elements 30 located at an adjacent row along the direction “c”. The second optical elements 30 in every two adjacent columns of the second optical elements 30 are arranged in a zigzag manner. That is, the second optical elements 30 located at one column are not in alignment with the second optical elements 30 located at an adjacent column along the direction “r”.

Each of the light penetrating plates 50, 60 is made of transparent material selected from glass or PMMA (polymethyl methacrylate). Referring to FIG. 1, the light penetrating plate 50 has a light inputting face 52 and a light outputting face 54. The top face 32 of each second optical element 30 is intimately adhered on the light inputting face 52 of the light penetrating plate 50.

The diffusion plate 40 is located between the two light penetrating plates 50, 60. By the diffusion of the diffusion plate 40, an evenness of light outputted from the light penetrating plate 50 is increased.

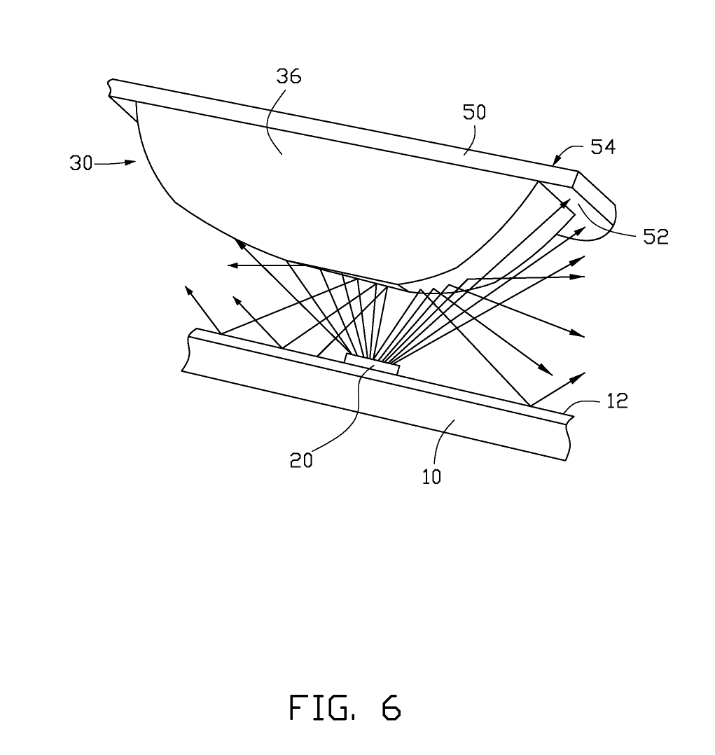

Referring to FIG. 1 and FIG. 6 simultaneously, when the LEDs 20 are powered to emit light, a first part of light emitted from the LEDs 20 with a bigger light outputting angle directly radiates on the light inputting face 52 of the light penetrating plate 50. A second part of light emitted from the LEDs 20 directly radiates on the first reflecting faces (i.e. the concave faces 34) of the second optical elements 30, and then is reflected to the reflecting face 12 of the first optical element 10 by the first reflecting faces of the second optical elements 30, and finally is reflected to the light inputting face 52 of the light penetrating plate 50 by the reflecting face 12 of the first optical element 10. A third part of light emitted from the LEDs 20 directly radiates on the second reflecting faces (i.e. the side faces 36) of the second optical elements 30, and then is reflected to the reflecting face 12 of the first optical element 10 by the second reflecting faces of the second optical elements 30, and finally is reflected to the light inputting face 52 of the light penetrating plate 50 by the reflecting face 12 of the first optical element 10. A fourth part of light emitted from the LEDs 20 directly radiates on the second reflecting faces (i.e. the side faces 36) of the second optical elements 30, and then is reflected to the light inputting face 52 of the light penetrating plate 50 by the second reflecting faces of the second optical elements 30. Finally, all of the light emitted from the LEDs 20 and entering the light inputting face 52 of the light penetrating plate 50 travels through the light penetrating plate 50, the diffusion plate 40 and the light penetrating plate 60 in sequence, to emit to an outside of the backlight module 100 for illuminating the LCD.

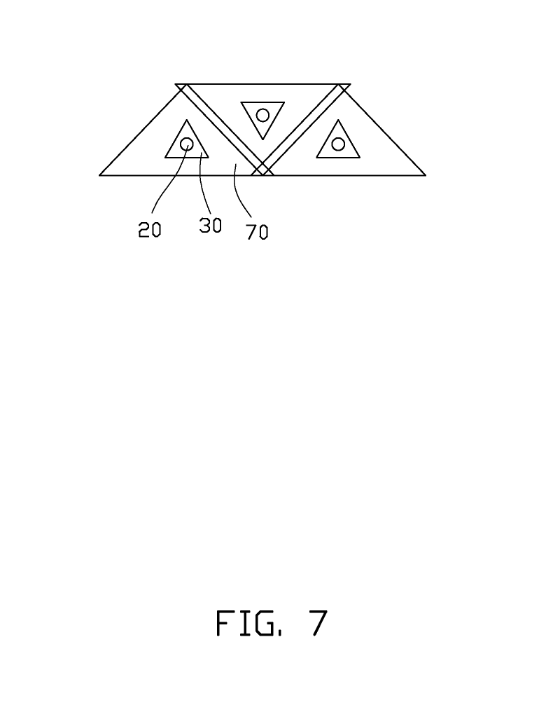

Also referring to FIG. 5, the light emitted from each LED 20 forms a triangular light field 70 after reflected by the first optical element 10 and the corresponding second optical element 30. Since the LEDs 20 are arranged on the reflecting face 12 of the first optical element 10 in a plurality of rows and a plurality of columns, wherein the LEDs 20 in every two adjacent rows of the LEDs 20 are arranged zigzag, and the LEDs 20 in every two adjacent columns of the LEDs 20 are arranged zigzag, the light emitted from every two adjacent LEDs 20 forms two adjacent triangular light fields 70 whose edges connect with each other (shown in FIG. 5) or linearly overlap each other (shown in FIG. 7). Therefore, the triangular light fields 70 formed by the light emitted from the LEDs 20 can be more evenly emitted into the diffusion plate 40 to be diffused thereby, whereby a more even/uniform light outputting effect of the backlight module 100 is achieved.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A backlight module, comprising:
a first optical element;
a plurality of LEDs (light emitting diodes) arranged on a reflecting face of the first optical element in a plurality of rows and a plurality of columns, the LEDs in every two adjacent rows of the LEDs being arranged zigzag, the LEDs in every two adjacent columns of the LEDs being arranged zigzag; and
a plurality of second optical elements located over and corresponding to the LEDs and spaced from the LEDs and the first optical element, the first optical element and the second optical elements reflecting light emitted from the LEDs, the light emitted from each LED forming a triangular light field after reflected by the first optical element and a corresponding second optical element.

2. The backlight module of claim 1, wherein the light emitted from two adjacent LEDs forms two adjacent triangular light fields whose edges connecting with each other.

3. The backlight module of claim 1, wherein the light emitted from two adjacent LEDs forms two adjacent triangular light files whose edges overlapping each other.

4. The backlight module of claim 1 further comprising a diffusion plate located above the second optical elements.

5. The backlight module of claim 4, further comprising two light penetrating plates located above the second optical elements, wherein the diffusion plate is located between the two light penetrating plates.

6. The backlight module of claim 5, wherein the second optical elements are adhered on one of the two light penetrating plates which is located between the second optical elements and the diffusion plate.

7. The backlight module of claim 6, wherein the diffusion plate and the two light penetrating plates are spaced from each other.

8. The backlight module of claim 1, wherein each second optical element comprises a triangular top face, three side faces connecting the top face, and a concave face formed in a bottom of the each second optical element, the concave face acting as a first reflecting face of the each second optical element and being oriented to a corresponding one of the LEDs, each side face acting as a second reflecting face of the each second optical element and facing the reflecting face of the first optical element.

9. The backlight module of claim 8, wherein the concave face has a profile like a pyramid with three triangular side surfaces.

10. The backlight module of claim 8, wherein each side face of the each second optical element is an arc-shaped face gradually tapering from the top face to the concave face.

11. The backlight module of claim 8 further comprising a light penetrating plate located above the second optical elements, the top faces of the second optical elements being adhered on the light penetrating plate.

12. The backlight module of claim 8, wherein a light outputting face of each LED faces the side faces and the concave face of the corresponding second optical element.

13. The backlight module of claim 2, wherein each of the second optical elements is configured as an inverted frustum of a triangular cone.

14. The backlight module of claim 3, wherein each of the second optical elements is configured as an inverted frustum of a triangular cone.

15. The backlight module of claim 5, wherein the light penetrating plates are made of transparent material selected from glass or PMMA.

16. A backlight module comprising:
a first optical element having a reflecting face;
a plurality of LEDs arranged on the reflecting face of the first optical element; and
a plurality of second optical elements located over the LEDs and spaced from the LEDs and the first optical element, each of the second optical elements corresponding to one LED and comprising a triangular top face, three side faces connecting the top face, and a concave face formed in a bottom of the each second optical element; wherein light emitted from each of the LEDs is reflected by the concave face, the side faces of a corresponding second optical element and by the reflecting face of the first optical element to form a triangular light field.
